(19) United States
(12) Patent Application Publication
(10) Pub. No.: US 2023/0302700 A1
(43) Pub. Date: Sep. 28, 2023

(54) MOLD-CLAMPING DEVICE

(71) Applicant: FANUC CORPORATION, Minamitsuru-gun (JP)

(72) Inventor: Masatoshi SENGA, Minamitsuru-gun, Yamanashi-ken (JP)

(21) Appl. No.: 18/020,807

(22) PCT Filed: Aug. 11, 2021
(86) PCT No.: PCT/JP2021/029588

§ 371 Date: Feb. 10, 2023

(30) Foreign Application Priority Data
Aug. 13, 2020 (JP) 2020-136746

(51) Int. Cl. B29C 45/64; B29C 45/17

(52) U.S. Cl. CPC B29C 45/64; B29C 45/1744

(57) ABSTRACT

Provided is a mold-clamping device that can inhibit inclination of a platen. A mold-clamping device according to an embodiment is provided with a supporting member that is provided on a base and supports a movable platen. The supporting member is provided with a pillar portion extending away from the base, and a joint portion which extends from the pillar portion toward a fixed platen along an extension direction of a tie bar and is joined to the movable platen.

### TECHNICAL FIELD

The present invention relates to a mold clamping device (mold-clamping device) for an injection molding machine.

### BACKGROUND ART

The injection molding machine includes a mold clamping device that opens and closes a mold, and an injection device that injects resin into the mold. JP 2014-040087 A discloses a mold clamping device having a stationary platen and a rear platen provided on a base so as to be spaced apart from each other, and a movable platen provided movably along a plurality of tie bars connecting the stationary platen and the rear platen. In JP 2014-040087 A, the stationary platen and the movable platen are disposed parallel to each other.

### SUMMARY OF THE INVENTION

There are cases where the mold temperature may be set to be higher than room temperature in response to request for improving the mold transferability or the like. In these cases, heat generated in the mold is transmitted to the tie bars, and then the tie bars thermally expand. As a result, there is a concern that at least one of the stationary platen and the movable platen may be inclined and the parallelism between the stationary platen and the movable platen may be lost.

In the mold clamping device, due to factors such as heat generated in the mold escaping to the base through the stationary platen and the movable platen, the temperature on a side opposite to the base side tends to be higher than that on the base side. Therefore, in the case of JP 2014-040087 A, the thermal expansion of the tie bar farther from the base tends to be larger than the thermal expansion of the tie bar closer to the base. Therefore, in JP 2014-040087 A, at least one of the stationary platen and the movable platen is easily inclined such that the distance between the stationary platen and the movable platen increases with increasing distance from the base.

Therefore, the present invention provides a mold clamping device capable of suppressing the inclination of platens.

According to a first aspect of the present invention, there is provided a mold clamping device for an injection molding machine, the mold clamping device including: a base; a stationary platen fixed to the base; a rear platen disposed on the base so as to be spaced apart from the stationary platen; a plurality of tie bars that connect the stationary platen and the rear platen; and a movable platen through which the tie bars penetrate and which is provided to be movable along an extending direction in which the tie bars penetrating therethrough extend, wherein the mold clamping device further includes a support member provided on the base and configured to support the movable platen, and the support member includes: a support column extending in a direction away from the base; and a connecting portion extending from the support column toward the stationary platen along the extending direction and connected to the movable platen.

According to a second aspect of the present invention, there is provided a mold clamping device for an injection molding machine, the mold clamping device including: a base; a stationary platen fixed to the base; a rear platen disposed on the base so as to be spaced apart from the stationary platen; a plurality of tie bars that connect the stationary platen and the rear platen; and a movable platen through which the tie bars penetrate and which is provided to be movable along an extending direction in which the tie bars penetrating therethrough extend, wherein the mold clamping device further includes a support member provided on the base and configured to support the stationary platen, and the support member includes: a support column extending in a direction away from the base; and a connecting portion extending from the support column toward the movable platen along the extending direction and connected to the stationary platen.

According to the aspects of the invention, it is possible to suppress the inclination of the platen.

That is, in the first aspect, when the tie bars thermally expand, a force acts on the movable platen in the direction toward the rear platen, whereas when the connecting portions thermally expand, a force acts on the movable platen in the direction toward the stationary platen. On the other hand, in the second aspect, when the tie bars thermally expand, a force acts on the stationary platen in a direction that is opposite to the direction toward the movable platen, whereas when the connecting portions thermally expand, a force acts on the stationary platen in the direction toward the movable platen.

That is, in both of the first aspect and the second aspect, the force acting on the platen due to the thermal expansion of the tie bars can be canceled by the force acting on the platen due to the thermal expansion of the connecting portions.

Therefore, it is possible to suppress the stationary platen or the movable platen from being inclined such that the parallelism between the stationary platen and the movable platen is lost.

In this way, the inclination of the platen can be suppressed.

### BRIEF DESCRIPTION OF DRAWINGS

FIG. 1 is a schematic view showing a mold clamping device according to a first embodiment;

FIG. 2 is a view showing the movable platen of FIG. 1 and its periphery;

FIG. 3 is a conceptual diagram showing how a force is generated in the mold clamping device of the first embodiment;

FIG. 4 is a schematic view showing a mold clamping device according to a second embodiment;

FIG. 5 is a view showing the stationary platen of FIG. 4 and its periphery; and

FIG. 6 is a conceptual diagram showing how a force is generated in the mold clamping device according to the second embodiment.

### DETAILED DESCRIPTION OF THE INVENTION

Preferred embodiments of the present invention will be described below in detail with reference to the accompanying drawings.

### First Embodiment

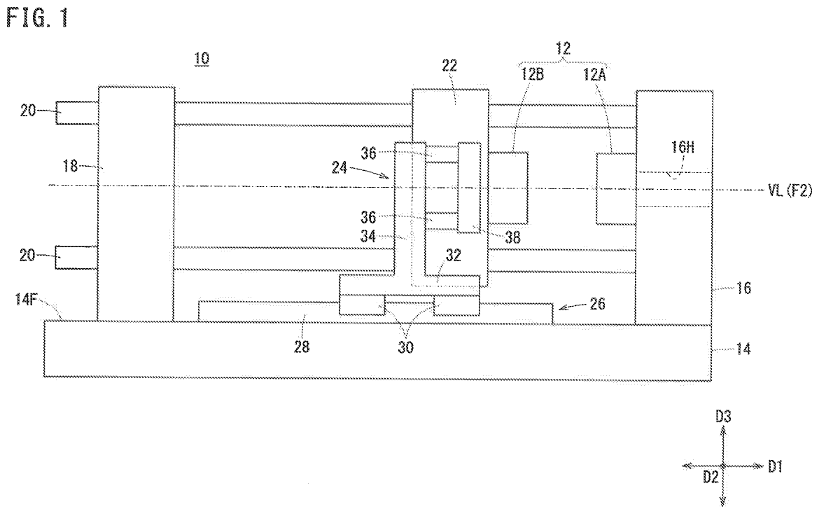

FIG. 1 is a schematic view showing a mold clamping device 10 of a first embodiment. FIG. 1 shows a first direction D1, a second direction D2, and a third direction D3 that are orthogonal to each other.

The mold clamping device 10 is a device for opening and closing a mold 12 composed of a fixed mold 12A and a movable mold 12B. The mold clamping device 10 includes a base 14, a stationary platen 16, a rear platen 18, a plurality of tie bars 20, a movable platen 22, and a support member 24.

The base 14 is a pedestal for mounting the mold clamping device 10. The length direction of the base 14 coincides with the first direction D1. The width direction of the base 14 coincides with the second direction D2. The height direction of the base 14 coincides with the third direction D3. A mounting surface 14F of the base 14 on which the mold clamping device 10 is mounted may be disposed horizontally or may be disposed in a direction other than the horizontal direction. In the present embodiment, the mounting surface 14F of the base 14 is disposed horizontally. In the present embodiment, among the directions orthogonal to the mounting surface 14F, a direction away from the mounting surface 14F toward the mold clamping device 10 is referred to as an upward direction, and a direction away from the mounting surface 14F toward the base 14, i.e., a direction opposite to the upward direction, is referred to as a downward direction.

The stationary platen 16 is fixed to the base 14. The stationary platen 16 extends upward from the mounting surface 14F of the base 14. A through hole 16H is formed in the stationary platen 16. The through hole 16H is a hole into which a nozzle of an injection device that injects resins into the mold 12 is inserted. The through hole 16H penetrates through the stationary platen 16 along the first direction D1. The fixed mold 12A is attached to a surface of the stationary platen 16 that is opposite to a surface thereof facing toward the injection device.

The rear platen 18 is disposed on the opposite side of the stationary platen 16 from the injection device. The rear platen 18 is separated from the stationary platen 16. The rear platen 18 extends upward from the mounting surface 14F of the base 14. The rear platen 18 may be fixed to the base 14 or may be provided to be movable with respect to the base 14.

Each of the plurality of tie bars 20 is a rod-shaped member that connects the stationary platen 16 and the rear platen 18. One of both ends of each tie bar 20 is fixed to the stationary platen 16. The other of both ends of each tie bar 20 is fixed to the rear platen 18. The plurality of tie bars 20 extend in the same extending direction. In the present embodiment, the number of tie bars 20 is four. The extending direction of each of the four tie bars 20 is the first direction D1. Further, in the present embodiment, two of the four tie bars 20 are disposed above the through hole 16H. The distances of the two tie bars 20 from the mounting surface 14F are substantially the same. The remaining two of the four tie bars 20 are disposed below the through hole 16H. The distances of the remaining two tie bars 20 from the mounting surface 14F are substantially the same.

The movable platen 22 is arranged between the stationary platen 16 and the rear platen 18. The movable platen 22 is provided to be movable along the extending direction of the tie bars 20. Each of the four tie bars 20 penetrates through the movable platen 22. The movable mold 12B is attached to a region, of the movable platen 22, that is within the four tie bars 20 and that faces the stationary platen 16.

The support member 24 supports the movable platen 22. The support member 24 is provided on the base 14 via a guide member 26. The guide member 26 is not particularly limited as long as the guide member can guide the support member 24 so as to be slidable along the extending direction of the tie bars 20 relative to the base 14. In the present embodiment, the guide member 26 is mounted on the mounting surface 14F of the base 14. In the present embodiment, the guide member 26 includes a guide rail 28 extending along the first direction D1 and a slide portion 30 fitted to the guide rail 28.

The support member 24 is fixed to the slide portion 30 so as not to interfere with the sliding of the slide portion 30 relative to the guide rail 28. Therefore, the movable platen 22 supported by the support member 24 can move in the mold clamping direction and the mold opening direction along the extending direction of the tie bars 20. The mold clamping direction is a direction in which the movable mold 12B is closed with respect to the fixed mold 12A attached to the stationary platen 16. The mold opening direction is a direction in which the movable mold 12B is opened with respect to the fixed mold 12A.

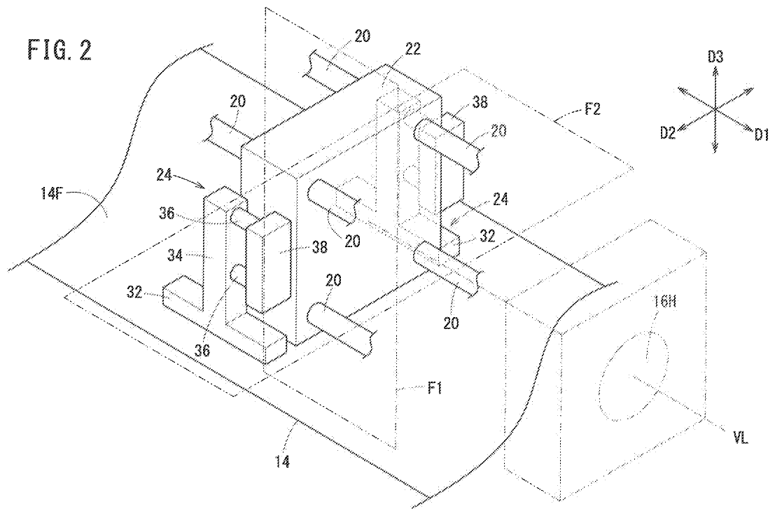

FIG. 2 is a view showing the movable platen 22 of FIG. 1 and its periphery. The support members 24 are disposed symmetrically with respect to a plane F1 (hereinafter referred to as an imaginary vertical plane F1) that passes through an imaginary line VL and that is orthogonal to the mounting surface 14F of the base 14. The imaginary line VL is an imaginary line that passes through the center of the through hole 16H of the stationary platen 16 and extends straight along the extending direction of the tie bars 20. Like the support members 24, the guide members 26 are also arranged symmetrically with respect to the imaginary vertical plane F1. In FIG. 2, the guide members 26 and the movable mold 12B are omitted.

The two support members 24 are of the same structure. Therefore, only one support member 24 will be described below. The support member 24 includes a foot portion 32, a support column 34, and a connecting portion 36.

The foot portion 32 is a base portion of the support member 24. The foot portion 32 is fixed to the slide portion 30 (FIG. 1) of the guide member 26. The shape and number of the foot portions 32 are not particularly limited. In the present embodiment, as shown in FIG. 2, one foot portion 32 is formed into a rod shape extending along the first direction D1. The foot portion 32 may be omitted.

The support column 34 is a portion extending in a direction away from the base 14 (i.e., extending upward). The support column 34 is disposed closer to the rear platen 18 than a surface of the movable platen 22 that faces toward the stationary platen 16 (see FIG. 1). The support column 34 is fixed to the foot portion 32. When the foot portion 32 is omitted, the support column 34 is fixed to the slide portion 30 of the guide member 26. The support column 34 may be formed integrally with the foot portion 32 (or the slide portion 30), or may be connected to the foot portion 32 (or the slide portion 30) by a fastener such as a bolt. The shape and the number of the support columns 34 are not particularly limited. In the present embodiment, as shown in FIG. 2, one support column 34 is formed into a rod shape extending along the third direction D3, and is molded integrally with the foot portion 32.

The connecting portion 36 extends from the support column 34 toward the stationary platen 16 along the extending direction of the tie bars 20. The connecting portion 36 is coupled to the movable platen 22. The connecting portion 36 is disposed closer to the rear platen 18 than the surface of the movable platen 22 facing toward the stationary platen 16 (see FIG. 1). The connecting portion 36 may be formed integrally with the support column 34, or may be connected to the support column 34 by a fastener such as a bolt. The connecting portion 36 extending from the support column 34 is fixed to a projecting member 38 provided on the movable platen 22. The connecting portion 36 is fixed to the projecting member 38, for example, by using a fastener such as a bolt disposed along the first direction D1.

The projecting member 38 is a member that protrudes from the movable platen 22 toward the outside in the width direction (second direction D2) of the base 14 orthogonal to the extending direction (first direction D1) of the tie bars 20. The projecting member 38 may be formed integrally with the movable platen 22 or may be connected to the movable platen 22 by a fastener such as a bolt.

The shape and the number of the connecting portions 36 are not particularly limited. In the present embodiment, the number of the connecting portions 36 in each support member 24 is two. Each of the two connecting portions 36 is formed into a rod shape. Each of the two connecting portions 36 extends from the support column 34 toward the stationary platen 16 along the extending direction (the first direction D1) of the tie bars 20. The two connecting portions 36 are disposed respectively on the lower side (the base 14 side, i.e., the side which is closer to the base) and the upper side (the side opposite to the base 14 side, i.e., the side which is farther away from the base) with respect to the imaginary line VL. As shown in FIGS. 1 and 2, the two connecting portions 36 are disposed symmetrically with respect to a plane F2 (hereinafter referred to as an imaginary parallel plane F2) that passes through the imaginary line VL and that is parallel to the mounting surface 14F of the base 14.

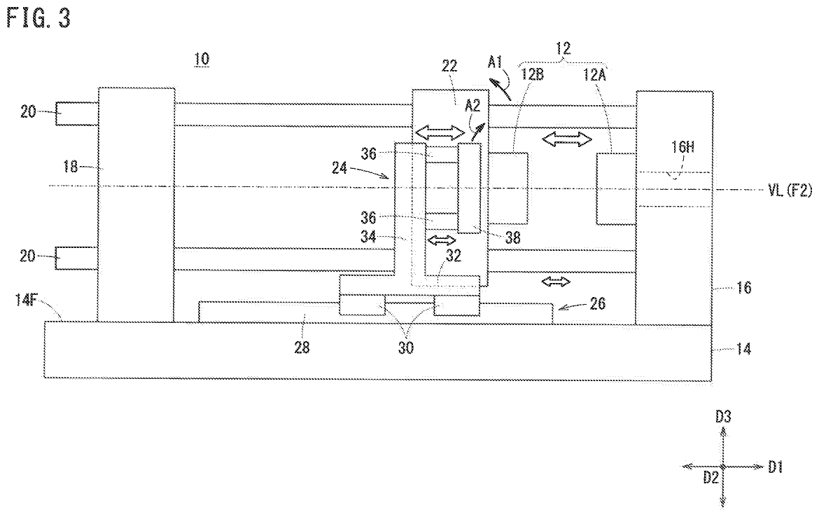

FIG. 3 is a conceptual diagram showing how a force is generated in the mold clamping device 10 of the first embodiment. Thermal expansion of the tie bars 20 occurs between the stationary platen 16 and the movable platen 22 of the mold clamping device 10, due to heat generated in the mold 12. The degree of thermal expansion of the tie bars 20 disposed on the upper side (the side opposite to the base 14 side) tends to be larger than the degree of thermal expansion of the tie bars 20 disposed on the lower side (the base 14 side). Therefore, a force acts on the movable platen 22 so as to tilt the movable platen 22 toward the rear platen 18 as indicated by an arrow A1.

On the other hand, the support member 24 supporting the movable platen 22 also thermally expands due to the heat generated in the mold 12. The degree of thermal expansion of the connecting portion 36 disposed on the upper side (the side opposite to the base 14 side) tends to be larger than the degree of thermal expansion of the connecting portion 36 disposed on the lower side (the base 14 side). Therefore, as indicated by an arrow A2, a force acts on the movable platen 22 so as to tilt the movable platen 22 toward the stationary platen 16. That is, the force received by the movable platen 22 due to the thermal expansion of the connecting portions 36 acts so as to cancel the force received by the movable platen 22 due to the thermal expansion of the tie bars 20. As long as the connecting portions 36 in the support member 24 extend from the support column 34 toward the stationary platen 16 along the extending direction of the tie bars 20 and are connected to the movable platen 22, the above-described force relationship is established regardless of the number and positions of the tie bars 20 and the connecting portions 36.

As described above, in the present embodiment, the support member 24 supporting the movable platen 22 is coupled to the movable platen 22 by the connecting portions 36. The connecting portions 36 extend along the extending direction of the tie bars 20 from the support column 34, which is disposed closer to the rear platen 18 than the surface of the movable platen 22 facing the stationary platen 16. Thus, the force acting on the movable platen 22 due to the thermal expansion of the tie bars 20 can be canceled by the force acting on the movable platen 22 due to the thermal expansion of the connecting portions 36. Therefore, it is possible to suppress the movable platen 22 from being inclined such that the parallelism between the stationary platen 16 and the movable platen 22 is lost.

The support member 24 of the present embodiment is provided on the base 14 via the guide member 26. Accordingly, it is possible to support the movable platen 22 while suppressing the moving load of the movable platen 22.

The support members 24 of the present embodiment are arranged symmetrically with respect to the imaginary vertical plane F1. Accordingly, it is possible to suppress variation in the supporting force of the two support members 24 with respect to the movable platen 22, and thus it is possible to stably support the movable platen 22.

The connecting portions 36 of the support members 24 of the present embodiment are fixed to the projecting members 38 that protrude outward from the movable platen 22 in the width direction (the second direction D2) of the base 14. Thus, the support members 24 can be disposed outside the movable region of the movable platen 22.

The two connecting portions 36 supported by each support member 24 are disposed on the lower side (the base 14 side) and the upper side (the side opposite to the base 14 side) with respect to the imaginary line VL. With this configuration, when the connecting portions 36 thermally expand, it is possible to generate a force acting on the movable platen 22 so as to tilt the movable platen 22 toward the stationary platen 16.

The connecting portions 36 are arranged symmetrically with respect to the imaginary parallel plane F2. Accordingly, it is possible to suppress variation in the supporting force of the support member 24 with respect to the movable platen 22, and thus it is possible to stably support the movable platen 22.

### Second Embodiment

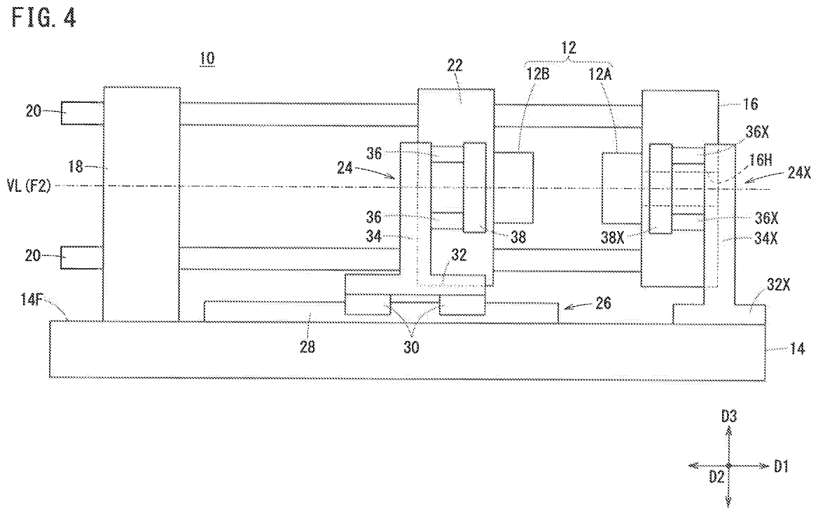

FIG. 4 is a schematic view showing the mold clamping device 10 of the second embodiment. In FIG. 4, the same components as those described in the first embodiment are denoted by the same reference numerals. In the second embodiment, descriptions that overlap or are duplicative of those stated in the first embodiment are omitted.

In the mold clamping device 10 of the second embodiment, a support member 24X is newly provided. The support member 24X supports the stationary platen 16. The support member 24X is provided directly on the base 14 without interposing the guide member 26.

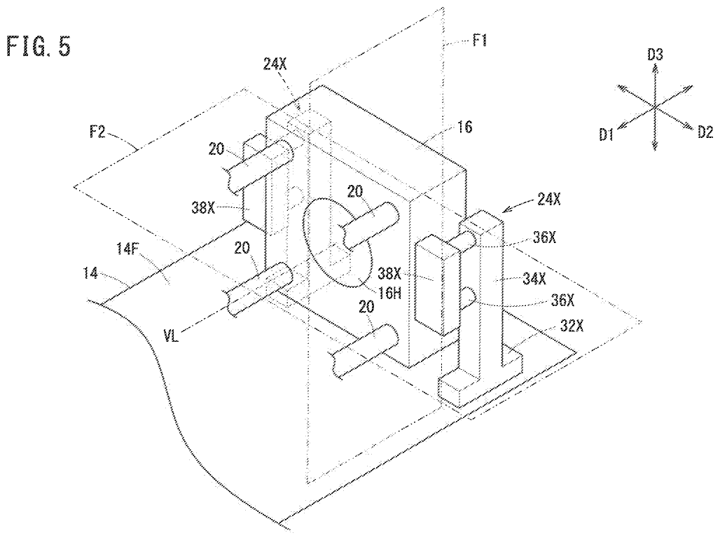

FIG. 5 is a view showing the stationary platen 16 of FIG. 4 and its periphery. In FIG. 5, the fixed mold 12A is omitted. Like the support members 24, the two support members 24X are arranged symmetrically with respect to the imaginary vertical plane F1. The structures of the two support members 24X are identical to each other. Therefore, only one support member 24X will be described below. The support member 24X includes a foot portion 32X, a support column 34X, and connecting portions 36X.

The foot portion 32X is a base portion of the support member 24X. The foot portion 32X is fixed to the base 14. The shape and number of the foot portions 32X are not particularly limited. In the present embodiment, as shown in FIG. 5, the number of foot portions 32X is one. The foot portion 32X is formed into a bar shape. The foot portion 32X extends along the first direction D1. The foot portion 32X may be omitted.

The support column 34X is a portion extending in a direction away from the base 14 (i.e., extending upward). The support column 34X is disposed closer to the injection device (i.e., further away from the movable platen 22) than a surface of the stationary platen 16 that faces toward the movable platen 22 (see FIG. 4). The support column 34X is fixed to the foot portion 32X. When the foot portions 32X are omitted, the support columns 34X are fixed to the base 14. The support column 34X may be formed integrally with the foot portion 32X (or the base 14), or may be connected to the foot portion 32X (or the base 14) by a fastener such as a bolt. The shape and the number of the support columns 34X are not particularly limited. In the present embodiment, as shown in FIG. 5, the number of the support columns 34X is one. The support column 34X is formed into a rod shape. The support column 34X extends along the third direction D3. The support column 34X may be formed integrally with the foot portion 32X.

The connecting portion 36X extends from the support column 34X toward the movable platen 22 along the extending direction of the tie bars 20. The connecting portion 36X is connected to the stationary platen 16. The connecting portion 36X is disposed closer to the injection device (i.e., on the side further away from the movable platen 22) than the surface of the stationary platen 16 facing the movable platen 22 (see FIG. 4). The connecting portion 36X may be formed integrally with the support column 34X, or may be connected to the support column 34X by a fastener such as a bolt. The connecting portion 36X extending from the support column 34X is fixed to a projecting member 38X provided on the stationary platen 16. The connecting portion 36X is fixed to the projecting member 38X, for example, by using a fastener such as a bolt disposed along the first direction D1.

The projecting member 38X is a member that protrudes from the stationary platen 16 toward the outside in the width direction (second direction D2) of the base 14 orthogonal to the extending direction (first direction D1) of the tie bars 20. The projecting member 38X may be formed integrally with the stationary platen 16 or may be connected to the stationary platen 16 by a fastener such as a bolt.

The shape and the number of the connecting portions 36X are not particularly limited. In the present embodiment, the number of the connecting portions 36X is two. Each of the two connecting portions 36X is formed into a rod shape. Each of the two connecting portions 36X extends from the support column 34X toward the movable platen 22 along the extending direction (the first direction D1) of the tie bars 20. The two connecting portions 36X are disposed respectively on the lower side (the base 14 side) and the upper side (the side opposite to the base 14 side) with respect to the imaginary line VL. As shown in FIGS. 4 and 5, the two connecting portions 36X are arranged symmetrically with respect to the imaginary parallel plane F2.

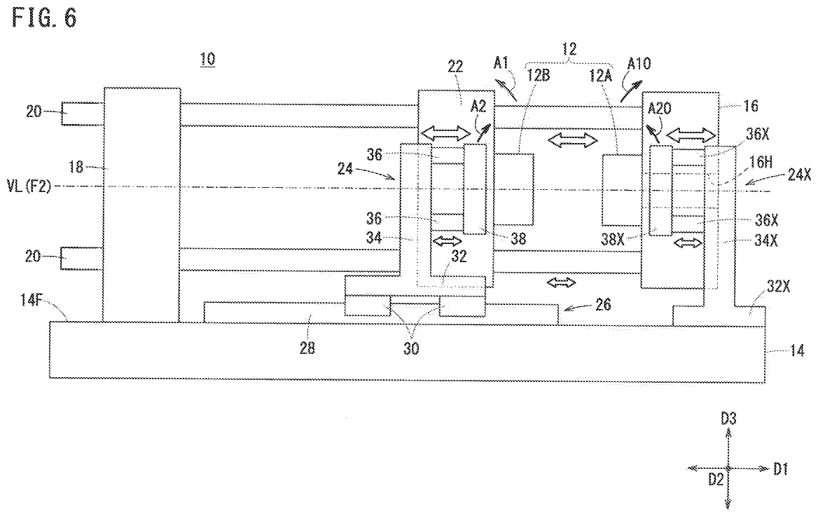

FIG. 6 is a conceptual diagram showing how a force is generated in the mold clamping device 10 of the second embodiment. Thermal expansion of the tie bars 20 occurs between the stationary platen 16 and the movable platen 22 of the mold clamping device 10, due to heat generated in the mold 12. The degree of thermal expansion of the tie bars 20 disposed on the upper side (the side opposite to the base 14 side) tends to be larger than the degree of thermal expansion of the tie bars 20 disposed on the lower side (the base 14 side). Therefore, as indicated by an arrow A10, a force acts on the stationary platen 16 so as to tilt the stationary platen 16 toward the injection device (i.e., away from the movable platen 22).

On the other hand, the support member 24X supporting the stationary platen 16 also thermally expands due to the heat generated in the mold 12. The degree of thermal expansion of the connecting portion 36X disposed on the upper side (the side opposite to the base 14 side) tends to be larger than the degree of thermal expansion of the connecting portion 36X disposed on the lower side (the base 14 side). Therefore, as indicated by an arrow A20, a force acts on the stationary platen 16 so as to tilt the stationary platen 16 toward the movable platen 22. That is, the force received by the stationary platen 16 due to the thermal expansion of the connecting portions 36X acts so as to cancel the force received by the stationary platen 16 due to the thermal expansion of the tie bars 20. As long as the connecting portions 36X in the support member 24X extend from the support column 34X toward the movable platen 22 along the extending direction of the tie bars 20 and are connected to the stationary platen 16, the above-described force relationship is established regardless of the number and positions of the tie bars 20 and the connecting portions 36X.

As described above, in the present embodiment, the support member 24X that supports the stationary platen 16 is coupled to the stationary platen 16 by the connecting portions 36X. The connecting portions 36X extend along the extending direction of the tie bars 20 from the support column 34X disposed closer to the injection device than the surface of the stationary platen 16 facing the movable platen 22. With this configuration, the force acting on the stationary platen 16 due to the thermal expansion of the tie bars 20 can be canceled by the force acting on the stationary platen 16 due to the thermal expansion of the connecting portions 36X. Therefore, it is possible to suppress the stationary platen 16 from being inclined such that the parallelism between the stationary platen 16 and the movable platen 22 is lost.

Further, in the present embodiment, since the support members 24 of the first embodiment are provided, it is possible to suppress inclination of both the stationary platen 16 and the movable platen 22. Therefore, it is possible to further suppress the loss of the parallelism between the stationary platen 16 and the movable platen 22.

The support members 24X of the present embodiment are arranged symmetrically with respect to the imaginary vertical plane F1. Accordingly, it is possible to suppress variation in the supporting force of the support members 24X with respect to the stationary platen 16, and it is possible to stably support the stationary platen 16.

The connecting portions 36X of each support member 24X of the present embodiment are fixed to the projecting member 38X that protrudes from the stationary platen 16 to the outside in the width direction (the second direction D2) of the base 14. Accordingly, the support member 24X can be disposed outside a region of the stationary platen 16 that lies on a side opposite to the side facing the movable platen 22.

The connecting portions 36X are disposed respectively on the lower side (the base 14 side) and the upper side (the side opposite to the base 14 side) with respect to the imaginary line VL. Accordingly, when the connecting portions 36X thermally expand, it is possible to generate a force acting on the stationary platen 16 so as to tilt the stationary platen 16 toward the movable platen 22.

The connecting portions 36X are disposed symmetrically with respect to the imaginary parallel plane F2. Accordingly, it is possible to suppress variation in the supporting force of the support members 24X with respect to the stationary platen 16, and it is possible to stably support the stationary platen 16.

### (Modifications)

Although preferred embodiments of the present invention have been described above, the present invention is not limited to the above-described embodiments, and various modifications can be made thereto within a range that does not depart from the essence and gist of the present invention.

For example, in the mold clamping device 10 of the second embodiment, the connecting portions 36 of the support members 24 and the projecting members 38 may be omitted. Further, in the mold clamping device 10 of the second embodiment, the support column 34 of the support member 24 may be fixed to the surface of the movable platen 22 that lies on the width direction (second direction D2) side of the base 14. The support column 34 is fixed to the movable platen 22, for example, by using a fastener such as a bolt disposed along the second direction D2. Even in this case, it is possible to prevent the parallelism between the stationary platen 16 and the movable platen 22 from being lost.

The above is summarized as follows.

The present invention is characterized by the mold clamping device (10) for the injection molding machine, the mold clamping device including: the base (14); the stationary platen (16) fixed to the base (14); the rear platen (18) disposed on the base (14) so as to be spaced apart from the stationary platen (16); the plurality of tie bars (20) that connect the stationary platen (16) and the rear platen (18); and the movable platen (22) through which the tie bars (20) penetrate and which is provided to be movable along the extending direction in which the tie bars (20) penetrating therethrough extend.

The mold clamping device (10) of a first aspect further includes the support member (24) provided on the base (14) and configured to support the movable platen (22). The support member (24) includes: the support column (34) extending in the direction away from the base (14); and the connecting portion (36) extending from the support column (34) toward the stationary platen (16) along the extending direction and connected to the movable platen (22). With this configuration, the force acting on the movable platen (22) due to the thermal expansion of the tie bars (20) can be canceled by the force acting on the movable platen (22) due to the thermal expansion of the connecting portions (36). Therefore, it is possible to suppress the movable platen (22) from being inclined such that the parallelism between the stationary platen (16) and the movable platen (22) is lost. In this way, the inclination of the platen can be suppressed.

The mold clamping device (10) of the first aspect may further include the guide member (26) configured to guide the support member (24) with respect to the base (14) in a manner so that the support member (24) is slidable along the extending direction, and the support member (24) may be provided on the base (14) via the guide member (26). Thus, it is possible to support the movable platen (22) while suppressing the moving load of the movable platen (22).

The mold clamping device (10) of the first aspect may further include the projecting member (38) provided on the movable platen (22) and protruding from the movable platen (22) toward the outside in the width direction of the base (14) orthogonal to the extending direction, and the connecting portion (36) extending from the support column (34) may be fixed to the projecting member (38). Thus, the support member (24) can be disposed outside the movable region of the movable platen (22).

The mold clamping device (10) of the second aspect further includes the support member (24X) provided on the base (14) and configured to support the stationary platen (16), and the support member (24X) may include: the support column (34X) extending in the direction away from the base (14); and the connecting portion (36X) extending from the support column (34X) toward the movable platen (22) along the extending direction and connected to the stationary platen (16). With this configuration, the force acting on the stationary platen (16) due to the thermal expansion of the tie bars (20) can be canceled by the force acting on the stationary platen (16) due to the thermal expansion of the connecting portions (36X). Therefore, it is possible to suppress the stationary platen (16) from being inclined such that the parallelism between the stationary platen (16) and the movable platen (22) is lost. In this way, the inclination of the platen can be suppressed.

The mold clamping device (10) of the second aspect may further include the projecting member (38X) provided on the stationary platen (16) and protruding from the stationary platen (16) toward the outside in the width direction of the base (14) orthogonal to the extending direction, and the connecting portion (36X) extending from the support column (34X) may be fixed to the projecting member (38X). With this configuration, the support member (24X) can be disposed outside the region of the stationary platen (16) that lies on the side opposite to the side facing the movable platen (22).

In the mold clamping device (10) of the first aspect or the second aspect, the connecting portion (36, 36X) may be disposed on each of the base (14) side and the opposite side which are opposite to each other with respect to the imaginary line (VL), the imaginary line (VL) passing through the center of the through hole (1611) of the stationary platen (16) through which the nozzle is inserted and extending straight along the extending direction. With this configuration, in the first aspect, when the connecting portions (36) thermally expand, a force that tilts the movable platen (22) toward the stationary platen (16) can be applied to the movable platen (22). According to the second aspect, when the connecting portions (36X) thermally expand, a force that tilts the stationary platen (16) toward the movable platen (22) can be applied to the stationary platen (16).

In the mold clamping device (10) of the first aspect or the second aspect, the connecting portions (36, 36X) may be disposed symmetrically with respect to the plane (F2) passing through the imaginary line (VL) and being parallel to the mounting surface (14F) of the base (14) on which the stationary platen (16) is mounted. With this configuration, it is possible to suppress variation in the supporting force of the support members (24, 24X) with respect to the platen, and it is possible to stably support the platen.

In the mold clamping device (10) of the first aspect or the second aspect, the support members (24, 24X) may be arranged symmetrically with respect to the plane (F1) that passes through the center of the through hole (16H) of the stationary platen (16) through which the nozzle is inserted, that passes through the imaginary line (VL) extending straight along the extending direction, and that is orthogonal to the mounting surface (14F) of the base (14) on which the stationary platen (16) is mounted. With this configuration, it is possible to suppress variation in the supporting force of the support members (24, 24X) with respect to the platen, and it is possible to stably support the platen.

1. A mold clamping device for an injection molding machine, the mold clamping device comprising:
a base;
a stationary platen fixed to the base;
a rear platen disposed on the base so as to be spaced apart from the stationary platen;
a plurality of tie bars that connect the stationary platen and the rear platen; and
a movable platen through which the tie bars penetrate and which is provided to be movable along an extending direction in which the tie bars penetrating therethrough extend,
wherein
the mold clamping device further comprises a support member provided on the base and configured to support the movable platen, and
the support member includes:
a support column extending in a direction away from the base; and
a connecting portion extending from the support column toward the stationary platen along the extending direction and connected to the movable platen.

2. The mold clamping device according to claim 1, further comprising:
a guide member configured to guide the support member with respect to the base in a manner so that the support member is slidable along the extending direction,
wherein the support member is provided on the base via the guide member.

3. The mold clamping device according to claim 1, further comprising:
a projecting member provided on the movable platen and protruding from the movable platen toward outside in a width direction of the base orthogonal to the extending direction,
wherein the connecting portion extending from the support column is fixed to the projecting member.

4. A mold clamping device for an injection molding machine, the mold clamping device comprising:
a base;
a stationary platen fixed to the base;
a rear platen disposed on the base so as to be spaced apart from the stationary platen;
a plurality of tie bars that connect the stationary platen and the rear platen; and
a movable platen through which the tie bars penetrate and which is provided to be movable along an extending direction in which the tie bars penetrating therethrough extend,
wherein
the mold clamping device further comprises a support member provided on the base and configured to support the stationary platen, and
the support member includes:
a support column extending in a direction away from the base; and
a connecting portion extending from the support column toward the movable platen along the extending direction and connected to the stationary platen.

5. The mold clamping device according to claim 4, further comprising:
a projecting member provided on the stationary platen and protruding from the stationary platen toward outside in a width direction of the base orthogonal to the extending direction,
wherein the connecting portion extending from the support column is fixed to the projecting member.

6. The mold clamping device according to claim 1, wherein
the connecting portion is disposed on each of a base side and an opposite side which are opposite to each other with respect to an imaginary line, the imaginary line passing through a center of a through hole of the stationary platen through which a nozzle is inserted and extending straight along the extending direction.

7. The mold clamping device according to claim 6, wherein
the connecting portions are disposed symmetrically with respect to a plane passing through the imaginary line and being parallel to a mounting surface of the base on which the stationary platen is mounted.

8. The mold clamping device according to claim 1, wherein
the support member comprises support members that are disposed symmetrically with respect to a plane that passes through a center of a through hole of the stationary platen through which a nozzle is inserted, that passes through an imaginary line extending straight along the extending direction, and that is orthogonal to a mounting surface of the base on which the stationary platen is mounted.

9. The mold clamping device according to claim 4, wherein
the connecting portion is disposed on each of a base side and an opposite side which are opposite to each other with respect to an imaginary line, the imaginary line passing through a center of a through hole of the stationary platen through which a nozzle is inserted and extending straight along the extending direction.

10. The mold clamping device according to claim 9, wherein
the connecting portions are disposed symmetrically with respect to a plane passing through the imaginary line and being parallel to a mounting surface of the base on which the stationary platen is mounted.

11. The mold clamping device according to claim 4, wherein
the support member comprises support members that are disposed symmetrically with respect to a plane that passes through a center of a through hole of the stationary platen through which a nozzle is inserted, that passes through an imaginary line extending straight along the extending direction, and that is orthogonal to a mounting surface of the base on which the stationary platen is mounted.
